(19) United States
(12) Patent Application Publication
(10) Pub. No.: US 2025/0389300 A1
(43) Pub. Date: Dec. 25, 2025

(54) FRICTION PLATE AND WET MULTI-PLATE CLUTCH INCLUDING FRICTION PLATE

(71) Applicant: NSK-Warner K.K., Tokyo (JP)

(72) Inventors: Masato KOBAYASHI, Fukuroi-shi (JP); Takeshi NISHISHITA, Fukuroi-shi (JP); Isami SATO, Fukuroi-shi (JP)

(21) Appl. No.: 19/238,392

(22) Filed: Jun. 14, 2025

(30) Foreign Application Priority Data
Jun. 21, 2024 (JP) 2024-100086

(51) Int. Cl. F16D 13/64; F16D 13/74; F16D 69/00

(52) U.S. Cl. CPC F16D 13/648; F16D 13/74; F16D 69/00; F16D 2069/004

(57) ABSTRACT

A friction plate 10 having a plurality of friction materials 12 fixed to a substantially annular core plate 3, wherein the friction plate 10 is provided with a plurality of oil passages 10g that communicate an inner peripheral edge 10i and an outer peripheral edge 10e of the friction plate 10, wherein the friction material 12 is provided with an oil groove 12g having one end opened to the inner peripheral edge 10i of the friction plate 10 and the other end closed between the inner and outer peripheral edges, wherein the oil groove 12g has a shape in which a width in a circumferential direction of the friction plate 10 decreases from the inner peripheral edge 10i toward the outer peripheral edge 10e and wherein the oil passage 10g and the oil groove 12g are inclined along a rotational direction of the friction plate.

### BACKGROUND OF THE INVENTION

### Field of the Invention

The present invention relates to a friction plate and a wet multi-plate clutch provided with the friction plate.

### Description of the Related Art

In general, in a wet multi-plate clutch, friction plates and separator plates are alternately arranged between a drum and a hub of a clutch or a brake, and the clutch is engaged and disengaged by pressing and releasing a clutch piston. In addition, in order to reduce power loss, a wet multi-plate clutch used in an automatic transmission (AT) often has a structure in which lubricant oil easily passes from the inner peripheral side to the outer peripheral side of a friction plate, thereby reducing drag torque between the friction plate and a separator plate.

Japanese Patent Application Laid-Open No. 2005-76759 discloses a friction plate having a configuration in which an oil passage communicating from an inner peripheral edge to an outer peripheral edge of a friction material attached on the friction plate and an oil groove opening to the inner peripheral edge and having an opening end portion in the middle of a friction surface are formed, and both the oil passage and the oil groove are gradually narrowed from the inner peripheral edge toward the outer periphery. In addition, Japanese Patent Application Laid-Open No. H10-169681 discloses a friction plate having a configuration in which a groove which communicates from an inside diameter portion to an outer diameter portion and is inclined along a rotational direction of an internally toothed disk is formed in a friction material fixed to the externally toothed disk.

### SUMMARY OF THE INVENTION

In Japanese Patent Application Laid-Open No. 2005-76759, both a reduction in drag torque and an improvement in friction characteristics are achieved by providing an oil groove and an oil passage. Further, in Japanese Patent Application Laid-Open No. H10-169681, a groove inclined along the rotational direction is provided to enhance the lubricant removal performance, thereby reducing the drag torque. However, in recent years, also in the automatic transmission, in order to reduce power loss at the time of non-engagement of the clutch, reduction of drag torque and prevention of rapid biting of the clutch at an initial stage at the time of frictional engagement have been further demanded.

An object of the present invention is to provide a friction plate capable of reducing drag torque and preventing rapid biting of a clutch at an initial stage of frictional engagement.

To attain the above object, the present invention provides a friction plate having a friction material fixed to a substantially annular core plate, wherein the friction plate is provided with a plurality of first oil grooves that communicate an inner peripheral edge and an outer peripheral edge of the friction plate, wherein the friction material is provided with a second oil groove having one end opened to the inner peripheral edge of the friction plate and the other end closed between the inner and outer peripheral edges, wherein the second oil groove has a shape in which a width in a circumferential direction of the friction plate decreases from the inner peripheral edge toward the outer peripheral edge of the friction plate, and wherein the first oil groove and the second oil groove are inclined along a rotational direction of the friction plate.

Further features of the present invention will become apparent from the following description of exemplary embodiments with reference to the attached drawings.

### BRIEF DESCRIPTION OF THE DRAWINGS

FIG. 1A is an axial partial cross-sectional view of a wet multi-plate clutch (100) of an embodiment provided with a friction plate (10) of the present invention. FIG. 1B is an axial partial cross-sectional view of a wet multi-plate clutch (200) of another embodiment provided with the friction plate (10) of the present invention.

FIG. 2A is a front view of the friction plate (10) of the present invention. FIG. 2B is a side view of the friction plate (10) of the present invention. FIG. 2C is a front view of one friction material (12).

FIG. 3A and FIG. 3B are partially enlarged views of the friction plate (10) for showing an enlarged view of the friction material (12) attached to the core plate (3) of the friction plate (10) of the present invention.

FIG. 4 is a schematic view showing the flow of the lubricant (L) in the friction plate (10) of the present invention.

FIG. 5 is analysis data showing the effect of the friction plate (10) of the present invention.

### DESCRIPTION OF THE EMBODIMENTS

### Embodiment

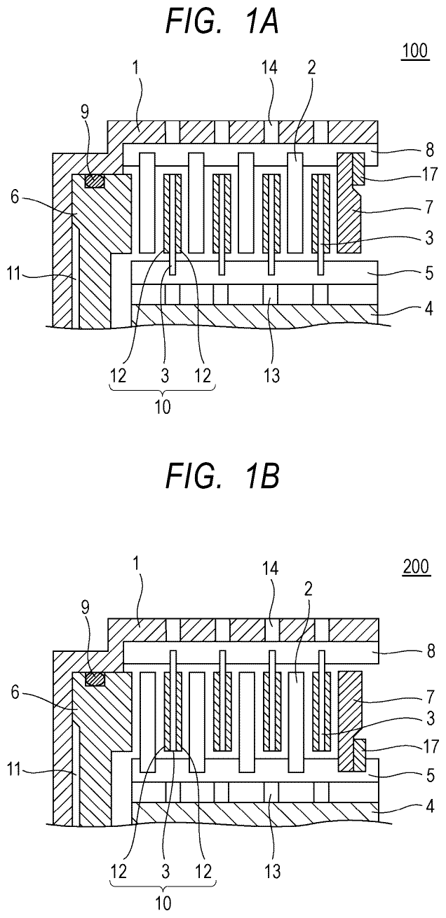

Hereinafter, the present invention will be described in detail with reference to the accompanying drawings. In the drawings, the same components are denoted by the same reference numerals, and the description thereof will be omitted. FIG. 1A is an axial partial cross-sectional view of a wet multi-plate clutch 100 of an embodiment provided with a friction plate 10 of the present invention.

The wet multi-plate clutch 100 comprises a substantially cylindrical clutch case 1 opened at one end in the axial direction, a hub 4 disposed on the inner periphery of the clutch case 1 and relatively rotated on the same axis, annular separator plates 2 disposed movably in the axial direction on splines 8 provided on the inner periphery of the clutch case 1, and annular friction plates 10 disposed alternately with the separator plates 2 in the axial direction on splines 5 provided on the outer periphery of the hub 4 and having friction materials 12 adhered to annular core plates 3. A plurality of separator plates 2 and a plurality of friction plates 10 are provided.

The clutch case 1 is provided with a plurality of through holes 14 in an outer peripheral portion. A lubricant L supplied from the inside diameter side and lubricating the clutch portion is moved to the outer diameter side by the centrifugal force to be discharged to the outside through a through hole 14. It goes without saying that the present invention can also be applied to a wet multi-plate clutch having a clutch case 1 in which the through hole 14 is not provided.

The wet multi-plate clutch 100 includes a piston 6 that presses and fastens the separator plates 2 and the friction plates 10 to bring the wet multi-plate clutch 100 into a fastened state, a backing plate 7 provided on the inner periphery of the clutch case 1 to hold the separator plates 2 and the friction plates 10 in a fixed state at one end in the axial direction, and a retaining ring 17 that holds the backing plate 7.

As shown in FIG. 1A, the piston 6 is disposed slidably in the axial direction in the closed end of the clutch case 1. An O-ring 9 is interposed between the outer peripheral surface of the piston 6 and the inner surface of the clutch case 1. A seal member (not shown) is also interposed between the inner peripheral surface of the piston 6 and the outer peripheral surface of the cylindrical portion (not shown) of the clutch case 1. Therefore, an oil-tight hydraulic chamber 11 is defined between the inner surface of the closed end of the clutch case 1 and the piston 6.

A friction material 12 having a predetermined friction coefficient is fixed to both surfaces of the friction plate 10 axially slidably held by the hub 4. However, the friction material 12 may be provided only on one surface of the friction plate 10. Further, the hub 4 is provided with a lubricant supplying port 13 penetrating in the radial direction, and the lubricant L is supplied from the inside diameter side to the outer diameter side of the wet multi-plate clutch 100.

FIG. 1B is an axial partial sectional view of a wet multi-plate clutch 200 of another embodiment provided with the friction plate 10 of the present invention. Since a basic configuration is the same as that of the wet multi-plate clutch 100 shown in FIG. 1A, only different portions will be described. In FIG. 1B, the spline engagement between the friction plate 10 and a separator plate 2 is reversed from that in FIG. 1A. In the wet multi-plate clutch 100 in the form of FIG. 1B, the friction plates 10 are engaged with the splines 8 of the clutch case 1, and the separator plates 2 are engaged with the splines 5 of the hub 4. The backing plate 7 and the retaining ring 17 for holding the backing plate 7 are also attached to the hub 4.

The wet multi-plate clutch 100 configured as described above engages and disengages the clutch as follows. FIG. 1A shows a clutch release state, in which the separator plate 2 and the friction plate 10 are separated from each other in a non-contact state. In a released state, the piston 6 is in contact with the closed end side of the clutch case 1 by an urging force of a return spring (not shown).

In order to engage the clutch in this state, hydraulic pressure is supplied to the hydraulic chamber 11 defined between the piston 6 and the clutch case 1. As the oil pressure increases, the piston 6 moves to the right in the axial direction in FIG. 1A against the biasing force of the return spring (not shown), and the separator plates 2 and the friction plates 10 are brought into close contact with each other. Thus, the clutch is engaged.

In order to release the clutch again after engagement, the oil pressure of the hydraulic chamber 11 is released. When the oil pressure is released, the piston 6 is moved by the urging force of a return spring (not shown) to a position where it abuts against the closed end of the clutch case 1. That is, the clutch is released. The same applies to the wet multi-plate clutch 200.

### Example

In recent years, a demand for low fuel consumption of an automobile has been increasing more and more, and also in an automatic transmission, in order to reduce power loss at the time of non-engagement of a clutch, reduction of drag torque and prevention of rapid biting of the clutch at an initial stage at the time of frictional engagement have been further required. Hereinafter, the friction plate 10 according to an embodiment of the present invention which meets the above-mentioned requirements will be described in detail.

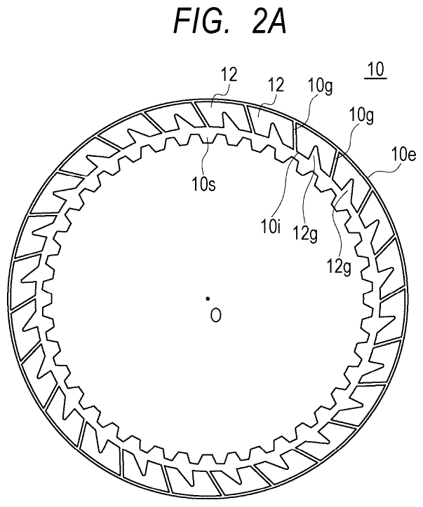

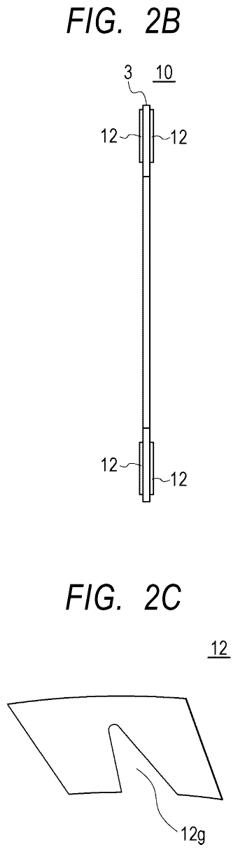

FIG. 2A is a front view of the friction plate 10 of the present invention. FIG. 2B is a side view of the friction plate 10. FIG. 2C is a front view of one friction material 12. The friction plate 10 is configured by fixing a plurality of the friction materials 12 shown in FIG. 2C in a substantially annular shape on a substantially annular core plate 3. The inner circumference of the friction plate 10 is formed with spline teeth 10s for spline-fitting with a counterpart member of torque transmission. The friction plate 10 is provided with a plurality of oil passages 10g (first oil groove) that communicate with the inner peripheral edge 10i and an outer peripheral edge 10e of the friction plate 10. The plurality of friction materials 12 are fixed to the friction plate 10 so that the oil passage 10g is formed between each friction material 12 and an adjacent friction material 12. The width of the oil passage 10g in the circumferential direction is substantially constant from the inner peripheral edge 10i to the outer peripheral edge 10e. An oil groove 12g (second oil groove) is provided on the surface of the friction material 12. One end of the oil groove 12g is open to the inner peripheral edge 10i of the friction plate 10, and the other end is closed between the inner and outer peripheral edges. The oil groove 12g has a shape in which the width in the circumferential direction of the friction plate 10 narrows from the inner peripheral edge 10i to the outer peripheral edge 10e of the friction plate 10.

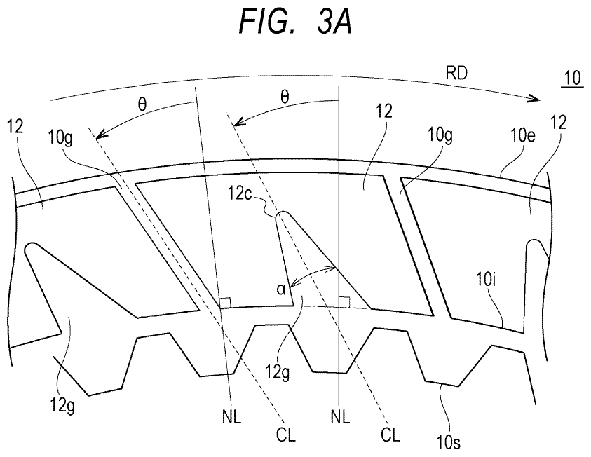

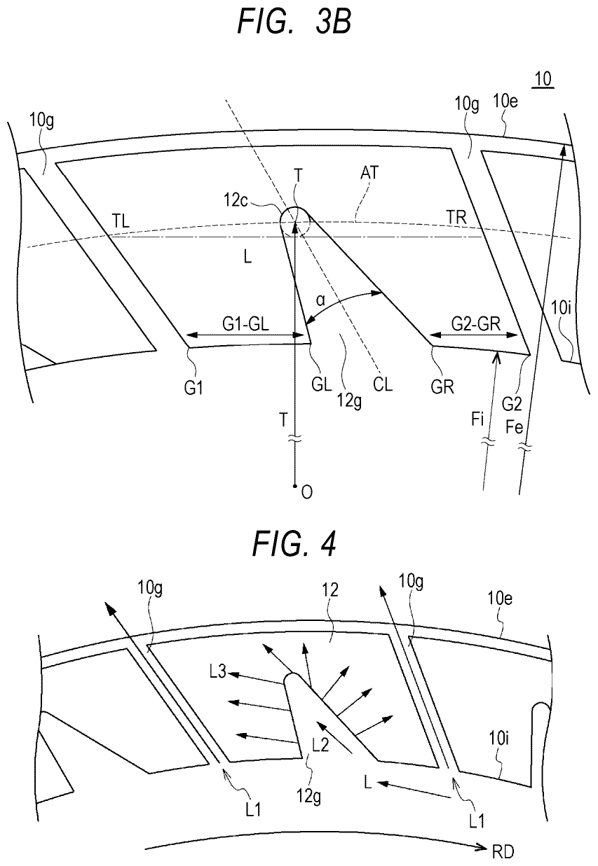

FIG. 3A and FIG. 3B are partially enlarged view of the friction plate 10 for showing an enlarged view of the friction material 12 attached to the core plate 3 of the friction plate 10 of the present invention. The oil groove 12g has an opening portion opened to the inner peripheral edge 10i and a closed portion 12c on the friction surface. The friction material 12 provided with the oil groove 12g is arranged on the core plate 3 of the friction plate 10 at a predetermined interval in the circumferential direction of the friction plate 10 so as to form the oil passage 10g and is fixed by an adhesive. Further, a plurality of the friction materials 12 is provided, the oil groove 12g is provided at substantially the center in the circumferential direction of each of the friction materials 12. The oil groove 12g and the oil passages 10g are alternately provided in the circumferential direction. As shown in FIG. 3A, both the oil passage 10g and the oil groove 12g are inclined in accordance with a rotational direction RD of the friction plate 10. Here, the configuration in which “the oil passage 10g and the oil groove 12g are inclined along the rotational direction RD of the clutch” refers to a direction in which, when the lubricant L given motion by the rotation of the clutch receives centrifugal force and moves from the inner side toward the outer side, the movement is not hindered. That is, the center line CL of the oil passage 10g and the oil groove 12g in the circumferential direction is inclined at an inclination angle θ (angle) opposite to the rotational direction RD with respect to the normal line NL of the inner peripheral edge 10i of the friction plate 10.

As shown in FIG. 3B, the oil groove 12g is provided substantially at the center in the circumferential direction between two adjacent oil passages 10g. The oil groove 12g extends obliquely from substantially the center in the circumferential direction of the friction material 12 and terminates at the closed portion 12c between the inner and outer peripheral edges. The closed portion 12c is not pointes and formed to have a substantially semicircular arc portion. Further, the width of the closed portion 12c (the diameter of the substantially semicircle) is shorter than the width of the opening portion of the oil groove 12g (GL-GR), and the oil groove 12g is formed to be gradually narrower in the direction from the inner peripheral edge 10i to the outer peripheral edge 10e. That is, the oil groove 12g is defined by two tapered surfaces which open in the direction of the inner peripheral edge 10i of the friction plate 10 at a predetermined opening angle α. The opening angle α of the oil groove 12g is set to a predetermined angle.

When the radius of the outer peripheral edge 10e of the friction plate 10 is defined as an outer radius Fe and the radius of the inner peripheral edge 10i of the friction plate 10 is defined as an inner radius Fi, the center T of the circular arc portion constituting a part of the closed portion 12c of the oil groove 12g is preferably positioned in the radial direction of the friction plate 10 so that the value of a constant R in the following expression becomes a value in the range of 0.2-0.8.

T=Fi+(Fe−Fi)×R

0.2≤R≤0.8

That is, it is preferable that the radial dimension of the oil groove 12g is approximately 20% to 80% of the radial dimension (Fe−Fi) of the friction plate 10.

Next, the position of the closed portion 12c (arc portion) of the oil groove 12g in the circumferential direction of the friction plate 10 will be described. When an arc AT, whose radius is the distance from the center O of the friction plate 10 to the center T of the arc portion, intersects with the oil passage 10g on the left side of the drawing at intersection point TL and with the oil passage 10g on the right side of the drawing at intersection point TR, it is preferable that the closed portion 12c is near a point that divides the straight line L connecting the intersection points TL and TR into approximately two equal parts.

It is preferable that the distance (G1-GL) from the intersection G1 of the inner peripheral edge 10i of the friction plate 10 and the left-side oil passage 10g to the intersection GL of the inner peripheral edge 10i of the friction plate 10 and the oil groove 12g on the left side of the drawing, and the distance (G2-GR) from the intersection G2 of the inner peripheral edge 10i of the friction plate 10 and the right-side oil passage 10g to the intersection GR of the inner peripheral edge 10i of the friction plate 10 and the oil groove 12g on the right side of the drawing, be 1 mm or more.

FIG. 4 is a schematic view showing the flow of the lubricant L in the friction plate 10 of the present invention. The lubricant L flows into the oil passage 10g and the oil groove 12g. A lubricant L1 flowing into the oil passage 10g flows toward the outer peripheral edge 10e. On the other hand, a lubricant L2 flowing into the oil groove 12g climbs over the oil groove 12g and becomes a lubricant L3. In this friction plate 10, an inclination angle θ is given to the oil groove 12g extending from an inner peripheral edge 10i side to an outer peripheral edge 10e side of the friction plate 10 and terminating between the inner and outer peripheral edges, and the rotational direction RD is limited to increase the inflowing lubricant L2. As a result, the force for separating the friction plate 10 and the separator plate 2 from each other increases, so that the drag torque can be significantly reduced.

Further, since the lubricant L3 overflowing from the oil groove 12g rides on the friction surface of the friction material 12, rapid biting of the clutch at the initial stage of engagement is prevented. The discharge performance of the inflowing lubricant L2 is remarkably improved.

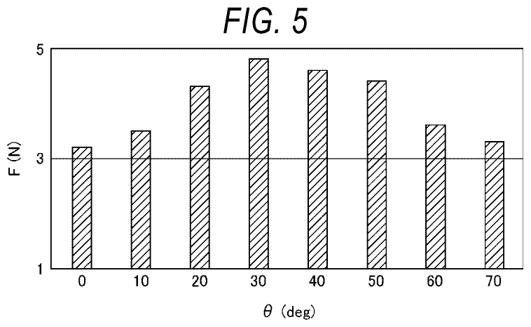

FIG. 5 is analysis data showing the effect of the friction plate 10 of the present invention. The horizontal axis represents the inclination angle θ (deg) of the oil passage 10g and the oil groove 12g, and the vertical axis represents the separation force F (N). According to the analysis data, it is found that an effective separation force F is obtained when the inclination angle θ is 20 to 50 degrees. More preferably, the largest separation force F can be obtained when the inclination angle θ is 30 degrees. The separation force F in the conventional example is obtained when the inclination angle θ is 0 degrees.

The embodiment in which the friction plate 10 is formed by annularly fixing the plurality of friction materials 12 on the substantially annular core plate 3 has been described above. However, the friction material 12 may have a substantially annular shape, and the oil passage 10g and the oil groove 12g may be alternately formed in the friction material 12 at predetermined intervals in the circumferential direction. The friction plate 10 may be configured such that the substantially annular friction material 12 is substantially coaxially attached to the core plate 3 of the friction plate 10.

Although the preferred embodiments of the present invention have been described above, the present invention is not limited to the embodiments, and various modifications and changes can be made within the scope of the gist of the present invention.

What is claimed is:

1. A friction plate having a friction material fixed to a substantially annular core plate,
wherein the friction plate is provided with a plurality of first oil grooves that communicate an inner peripheral edge and an outer peripheral edge of the friction plate,
wherein the friction material is provided with a second oil groove having one end opened to the inner peripheral edge of the friction plate and the other end closed between the inner and outer peripheral edges,
wherein the second oil groove has a shape in which a width in a circumferential direction of the friction plate decreases from the inner peripheral edge toward the outer peripheral edge of the friction plate, and
wherein the first oil groove and the second oil groove are inclined along a rotational direction of the friction plate.

2. The friction plate according to claim 1, wherein center lines of the first oil groove and the second oil groove in the circumferential direction are inclined at an angle opposite to the rotational direction with respect to a normal line of the inner circumferential edge of the friction plate.

3. The friction plate according to claim 2, wherein the angle is in a range of 20 degree to 50 degrees.

4. The friction plate of claim 2, wherein the angle is characterized by 30 degrees.

5. The friction plate according to claim 1, wherein the first oil groove and the second oil groove are provided alternately in the circumferential direction.

6. The friction plate according to claim 1, wherein a width of the first oil groove in the circumferential direction is substantially constant from the inner peripheral edge to the outer peripheral edge.

7. The friction plate according to claim 1, wherein the second oil groove is provided substantially at a center in the circumferential direction between two adjacent first oil grooves.

8. The friction plate according to claim 1, wherein the other end of the second oil groove terminates at a position in a range of approximately 20% to 80% of a width of the friction plate in the radial direction.

9. The friction plate according to claim 1, wherein the plurality of friction materials is attached to the core plate in a substantially annularly shape at substantially equal intervals and at predetermined intervals so as to form the first oil groove.

10. The friction plate according to claim 1, wherein the friction material is a substantially annular, the first oil groove and the second oil groove are alternately formed in the friction material at a predetermined interval in the circumferential direction, and the friction material is attached to the friction plate substantially coaxially.

11. A wet multi-plate clutch comprising:
the friction plate according to claim 1, and separator plates arranged alternately with the friction plate in an axial direction.

12. A wet multi-plate clutch comprising:
the friction plate according to claim 2, and separator plates arranged alternately with the friction plate in an axial direction.

13. A wet multi-plate clutch comprising:
the friction plate according to claim 3, and separator plates arranged alternately with the friction plate in an axial direction.

14. A wet multi-plate clutch comprising:
the friction plate according to claim 4, and separator plates arranged alternately with the friction plate in an axial direction.

15. A wet multi-plate clutch comprising:
the friction plate according to claim 5, and separator plates arranged alternately with the friction plate in an axial direction.

16. A wet multi-plate clutch comprising:
the friction plate according to claim 6, and separator plates arranged alternately with the friction plate in an axial direction.

17. A wet multi-plate clutch comprising:
the friction plate according to claim 7, and separator plates arranged alternately with the friction plate in an axial direction.

18. A wet multi-plate clutch comprising:
the friction plate according to claim 8, and separator plates arranged alternately with the friction plate in an axial direction.

19. A wet multi-plate clutch comprising:
the friction plate according to claim 9, and separator plates arranged alternately with the friction plate in an axial direction.

20. A wet multi-plate clutch comprising:
the friction plate according to claim 10, and separator plates arranged alternately with the friction plate in an axial direction.
